(19) United States
(12) Patent Application Publication
(10) Pub. No.: US 2008/0117097 A1
(43) Pub. Date: May 22, 2008

(54) Radar Transceivers

(76) Inventors: Thomas Walter, Renningen (DE); Dirk Steinbuch, Wimsheim (DE)

Correspondence Address: KENYON & KENYON LLP, ONE BROADWAY, NEW YORK, NY, 10004, US

(21) Appl. No.: 11/792,648

(22) PCT Filed: Nov. 15, 2005
(86) PCT No.: PCT/EP05/55980

§ 371 Date: Jun. 7, 2007

(30) Foreign Application Priority Data
Dec. 9, 2004 (DE) 102004059332.9

(51) Int. Cl. G01S 7/03

(52) U.S. Cl. 342/175

(57) ABSTRACT

A radar transceiver, including at least one oscillator tunable using a control voltage, at least one mixer, and at least one antenna for transmitting and receiving ultra-high-frequency signals, the mixer mixing the receive signal with the signal of the oscillator and outputting a demodulated signal, and in which the at least one oscillator, the at least one mixer, and the at least one antenna are situated on a single chip located next to one another in one plane.

### FIELD OF THE INVENTION

The present invention relates to a radar transceiver including at least one oscillator tunable using a control voltage, at least one mixer, and at least one antenna for transmitting and receiving ultra-high-frequency signals, the mixer mixing the receive signal with the signal of the oscillator and outputting a demodulated signal.

### BACKGROUND INFORMATION

Such radar transceivers, i.e., transmitter/receiver modules, are used in the microwave and millimeter wavelength ranges for positioning objects in space or for determining velocities, of motor vehicles for example. A radar transceiver of this type transmits ultra-high-frequency signals in the form of electromagnetic waves, which are reflected from the target object, received again by the radar transceiver and further processed, for positioning objects in space and for determining velocities. A plurality of such radar transceivers is often connected to form a single module. In the automobile industry, frequencies of approximately 77 GHz are used. Such radar transceivers are used in particular for the distance warning radar, which is used for determining the distance to another vehicle traveling ahead of the host vehicle and for outputting warning instructions when the distance between the two vehicles drops below a predefined threshold value.

German Patent Document No. DE 103 00 955 A1 discusses a radar transceiver of the generic type for microwave and millimeter wave applications having the following features:
at least one oscillator, which includes at least one active circuit element, at least one frequency-determining resonance circuit, and at least one component suitable for determining frequency,
at least one mixer, which includes at least one diode and at least one passive circuit element,
a substrate having at least two dielectric layers one above the other, metal plating layers being provided underneath and between the dielectric layers, the bottom side of the substrate having external contacts for contacting a system carrier, and the top side of the substrate having contacts for contacting the external electrodes of the at least one individual electronic component,
one or more individual electronic components situated on the top side of the substrate, which
include at least one active or non-linear circuit component of the mixer and
at least one active or non-linear circuit component of the voltage-controlled oscillator, the at least one passive circuit element of the mixer and/or the at least one resonance circuit of the voltage-controlled oscillator being integrated in a metal plating layer of the substrate.

All types of planar circuit boards may be used as the substrate. These include ceramic substrates (thin-layer ceramics, thick-layer ceramics, LTCC=Low Temperature Cofired Ceramics, HTCC=High Temperature Cofired Ceramics), LTCC and HTCC being ceramic multilayer circuits, polymer substrates, i.e., conventional circuit boards such as FR4 or soft substrates whose polymer base is made of PTFE, for example, and which are usually glass fiber-reinforced or ceramic powder-filled, silicon and metallic substrates in which metallic track conductors are insulated from a metallic baseplate by polymers or ceramic materials. Furthermore, molded interconnection devices (MID) made of thermoplastic polymers on which track conductors are structured may be used.

Microwave Monolithic Integrated Circuits (MMICs) of this type are thus combined with discrete components to form a multichip module (MCM). This MCM is applied to a substrate material, which contains ultra-high frequency wiring and antennas, like a conventional SMD component. The connection must be implemented in such a way as to enable the transmission of ultra-high frequency signals. In order to manufacture such HF junctions having reasonably low losses, the manufacturing process of such an MCM must meet very high standards.

### SUMMARY OF THE INVENTION

An object of the exemplary embodiments and/or exemplary methods of the present invention is to avoid such a complex arrangement of the MCM and its installation on a special board for ensuring the HF junctions and to provide a radar transceiver which not only has a compact arrangement and is easy to manufacture, but also is suitable for mounting on circuit carriers which are available, for example, conventional circuit boards and the like, in the simplest manner. This object may be achieved with a radar transceiver of the type according to the prevent invention described in the preamble in that the at least one oscillator, the at least one mixer, and the at least one antenna are situated on a single chip located next to one another in a one plane. Due to this arrangement, all radar functions are located on a single chip. By avoiding complex HF junctions, manufacturing is thus limited to simply gluing the chip (MMIC) on a regular low-frequency circuit board, an electric connection between the circuit elements of the circuit board and the chip being needed only in the low-frequency or DC range.

A phase-locking loop circuit for regulating the oscillator in a phase-locking loop may also be situated in the plane in which the oscillator, the mixer, and the antenna are located.

At least one amplifier, for example, an intermediate frequency amplifier, or an antenna amplifier for amplifying the transmitted and/or received signals, may also be situated in that plane.

The antenna may be a patch antenna, so that also in this case no HF connection is needed. Larger antennas may be linked in a contactless manner via an electromagnetic radiation link.

For contacting DC terminals and low-frequency connections, bond pads for contacting the radar transceiver after it has been installed on a circuit board, for example, are advantageously also situated in the plane of the chip.

The above-described arrangement as a single-chip front end system has the major advantage that manufacturing and processing are considerably less complex and less costly compared to the MMICs of the related art. All processes that are critical in manufacturing multichip modules are thus moved to the wafer manufacturing process, which has a very high degree of reproducibility.

Additional advantages and features of the exemplary embodiments and/or exemplary methods of the present invention are the subject matter of the description that follows and of the drawings illustrating the exemplary embodiments.

### BRIEF DESCRIPTION OF THE DRAWINGS

FIG. 1 shows a first exemplary embodiment of a radar transceiver according to the present invention.

FIG. 2 shows a second exemplary embodiment of a radar transceiver according to the present invention.

FIG. 3 schematically shows the arrangement of polyrods above patch antennas of radar transceivers according to the present invention.

### DETAILED DESCRIPTION

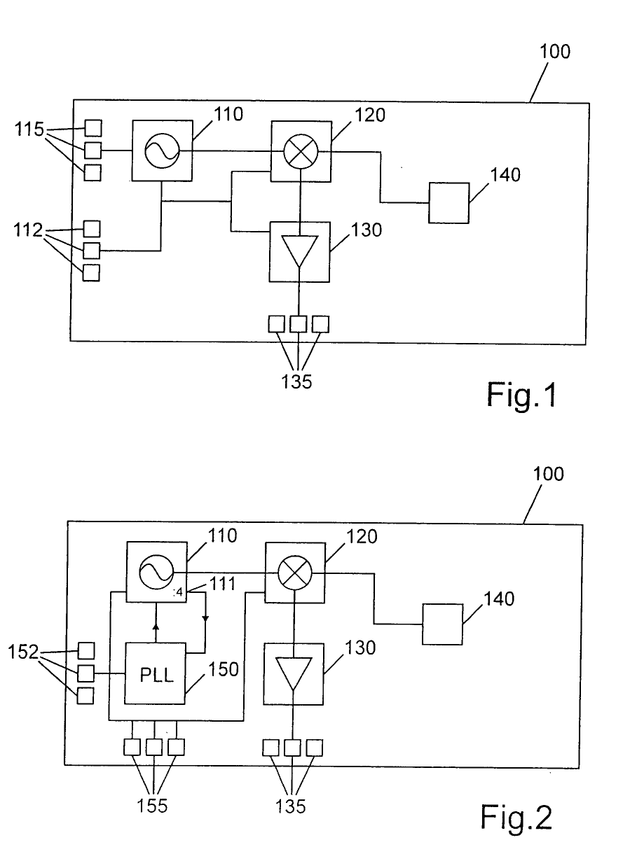

As FIG. 1 shows, a radar transceiver arranged as a single-chip front end (ECF) is implemented as a single silicon-germanium chip. A fundamental oscillator 110, which generates a frequency of 77 GHz, a mixer 120, an intermediate frequency amplifier 130, and at least one patch antenna 140 are situated next to one another in the plane of the chip.

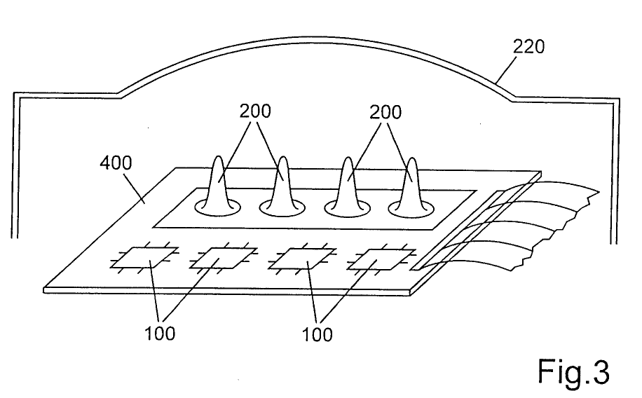

The signal generated by fundamental oscillator 110 is supplied to mixer 120. The antenna signal of patch antenna 140 is also supplied to mixer 120. This receive signal of patch antenna 140 is mixed with the signal of oscillator 110 in mixer 120, and a demodulated signal is output, which after amplification in intermediate frequency amplifier 130 is applied to corresponding bond pads 135 and from there is conveyed to components on a circuit board 400, on which the chip is situated (see FIG. 3) via essentially known bond wires.

Further bond pads 112 are provided for supplying voltage to oscillator 110; bond pads 115 are furthermore provided for frequency tuning, all bond pads being located in the plane of chip 100. Oscillator 110 is stabilized via an internal LC oscillator circuit. Its frequency may be tuned in an essentially known manner via a tuning input provided for this purpose, which is conductively connected to bond pads 115.

The radar transceiver depicted in FIG. 2 differs from the one depicted in FIG. 1 by the fact that, in addition to oscillator 110, mixer 120, amplifier 130, and antenna 140, a phase-locking loop (PLL) circuit 150, which is provided for regulating the oscillator in an essentially known phase-locking loop, is also situated in the plane of chip 100. In this case, oscillator 110 has an output 111, at which one-fourth of the frequency, for example, is output. This output is connected to PLL circuit 150 integrated in the plane of chip 100. In addition to bond pads 152 for voltage supply, bond pads 155 for tuning oscillator 110 via PLL circuit 150 on chip 100 are also provided here.

No antenna amplifiers are shown in the exemplary embodiments of FIGS. 1 and 2. Antenna amplifiers for amplifying signals sent with the aid of antenna 140 and/or for amplifying the signals received by this antenna may also be provided in the plane of chip 100.

Antenna 140 is a patch antenna, which is situated underneath a polyrod 200 (see FIG. 3) as provided for in German Patent Document No. DE 199 39 834 A1 and European Patent Document No. EP 1 121 726 B1, to which reference is hereby made for the purpose of the disclosure. Polyrod 200 bundles and irradiates the electromagnetic energy of antenna patch 140. A polyrod 200 of this type prefocuses onto a dielectric lens 220 in particular. There is no physical contact between polyrod 200 and chip 100 itself; rather polyrod 200 may be attached to a circuit board on which chip 100 is situated. The center of polyrod 200 is situated exactly above the center of patch antenna 140, as schematically shown in FIG. 3.

The advantage of the above-described radar transceiver is that all components of the transceiver are situated on a single chip 100. This makes not only simple manufacturing, but also a high level of integration possible. In addition, the HF conductor junctions, which interfere with the function of the transceiver, thus become largely superfluous.

1-8. (canceled)

9. A radar transceiver, comprising:
at least one oscillator tunable using a control voltage;
at least one mixer; and
at least one antenna for transmitting and receiving ultra-high-frequency signals;
wherein the mixer mixes a received signal with a signal of the oscillator and outputting a demodulated signal, and
wherein the at least one oscillator, the at least one mixer, and the at least one antenna are situated on a single chip located next to one another in one plane.

10. The radar transceiver of claim 9, wherein a phase-locking loop circuit for regulating the oscillator in a phase locked loop is situated in the plane.

11. The radar transceiver of claim 9, wherein at least one amplifier is situated in the plane.

12. The radar transceiver of claim 9, wherein the at least one antenna includes a patch antenna.

13. The radar transceiver of claim 9, wherein the patch antenna is situated underneath a polyrod.

14. The radar transceiver of claim 9, wherein the chip includes a silicon-germanium semiconductor element.

15. The radar transceiver of claim 9, wherein bond pads are situated in the plane.

16. The radar transceiver of claim 9, wherein the at least one oscillator generates a frequency of 77 GHz.
